(19) United States
(12) Patent Application Publication
(10) Pub. No.: US 2012/0266631 A1
(43) Pub. Date: Oct. 25, 2012

(54) SETTING FOR GEMSTONES, PARTICULARLY DIAMONDS

(76) Inventor: Rany MATTAR, Nazareth Ilit (IL)

(21) Appl. No.: 13/541,687

(22) Filed: Jul. 4, 2012

Related U.S. Application Data
(63) Continuation of application No. 11/712,478, filed on Mar. 1, 2007, now Pat. No. 8,215,126.

(51) Int. Cl. A44C 17/04; B28D 5/00; A44C 9/00; A44C 25/00; A44C 17/00; A44C 27/00

(52) U.S. Cl. 63/15; 63/32; 63/26; 63/28; 63/3; 125/30.01

(57) ABSTRACT

A setting for a gemstone including a girdle, a crown on one side of the girdle, and a pavilion on the opposite side of the girdle, characterized in that the setting mounts the gemstone in an inverted orientation such that the pavilion faces outwardly of the setting and the crown faces inwardly of the setting.

### RELATED APPLICATION

This application is a continuation of U.S. patent application Ser. No. 11/712,478 filed on Mar. 1, 2007, the contents of which are incorporated by reference as if fully set forth herein.

### FIELD AND BACKGROUND OF THE INVENTION

The present invention relates to new settings for gemstones, particularly diamonds, and also to jewelry pieces including such settings.

Diamonds and other gemstones are frequently mounted in various ways to produce different optical impressions and different optical effects. For example, one popular type of mounting includes an invisible setting, namely a setting which is not visible from the outer face of the gemstone. Invisible settings are particularly used when a plurality of such gemstones are mounted contiguously to each other so as to create the appearance of a single large gemstone. Many invisible settings have been devised for this purpose. The typical invisible settings in use today generally include prongs or the like received in grooves or notches formed in the pavilion of each gemstone so as to mount the gemstone with the crown facing outwardly, with the pavilion facing inwardly, and with the prongs concealed by the girdle.

### OBJECTS AND BRIEF SUMMARY OF THE PRESENT INVENTION

An object of the present invention is to provide a novel setting for gemstones, particularly for diamonds, which produces a novel optical appearance and which is particularly useful in an invisible setting.

According to a broad aspect of the present invention, there is provided an invisible setting for a gemstone including a girdle, a crown on one side of the girdle and normally oriented to face outwardly of the setting, and a tapered pavilion on the opposite side of the girdle of larger height than the crown and normally oriented to face inwardly of the setting; characterized in that the invisible setting mounts the gemstone in an inverted orientation with the pavilion facing outwardly of the setting and with the crown facing inwardly of the setting.

In the described preferred embodiments, the invisible setting includes prongs received in grooves formed in the crown of the gemstone and concealed by the girdle.

It will thus be seen that the novel setting as defined above mounts the gemstone in an inverse orientation with respect to the way the gemstone is normally mounted in a conventional setting. Such a setting produces a novel effect particularly when used for mounting a plurality of gemstones contiguously to each other.

Thus, according to another aspect of the present invention, there is provided a novel setting for a plurality of gemstones mounted contiguously to each other, each gemstone including a girdle, a crown on one side of the girdle, and a pavilion on the opposite side of the girdle; characterized in that the setting for at least some of the gemstones mounts the respective gemstone in an inverted orientation with the pavilion facing outwardly of the setting and with the crown facing inwardly of the setting. In the described preferred embodiment, the setting mounts all the gemstones such that the setting is concealed by the girdles of the gemstones, thereby producing an invisible setting creating the impression of a single large gemstone, rather than a plurality of gemstones.

In one described preferred embodiment, all the gemstones are mounted in the inverse orientation, with the pavilions facing outwardly of the setting, with the crowns facing inwardly of the setting, and with the setting concealed by the girdles. Described below are one arrangement wherein all the gemstones are mounted in a single row, and another arrangement wherein all the gemstones are mounted in a plurality of rows.

According to another described preferred embodiment, alternate gemstones are mounted in the inverse orientation with the pavilions facing outwardly, the crowns facing inwardly, and the prongs concealed by the girdles; whereas the remaining alternate gemstones are mounted in the normal orientation, with the crowns facing outwardly, the pavilions facing inwardly, and the prongs concealed by the girdles. Also in this arrangement, the gemstones may be mounted in a single row or in a plurality of rows.

In the above-described arrangements, the pavilions, in the inversely-oriented gemstones, may be blunted or formed with the normal culet.

For purposes of example, the invisible setting is described below with respect to a ring, but it will be appreciated that it could also be used in pendants, bracelets, or other articles of jewelry.

Further features and advantages of the invention will be apparent from the description below.

### BRIEF DESCRIPTION OF THE DRAWINGS

The invention is herein described, by way of example only, with reference to the accompanying drawings, wherein:

FIG. 1 illustrates a conventional prior art invisible setting for a single gemstone;

FIG. 2 illustrates a conventional prior art invisible setting for a plurality of gemstones;

FIG. 3 illustrates an invisible setting for a single gemstone in accordance with the present invention;

FIG. 4 illustrates an invisible setting for a row of gemstones in accordance with the present invention;

FIG. 5 illustrates an invisible setting arrangement for mounting a plurality of gemstones according to FIG. 4 in a plurality of rows;

FIGS. 6 and 7 are views, corresponding to FIGS. 4 and 5, respectively, illustrating another invisible setting arrangement for mounting a plurality of gemstones in accordance with the present invention;

and FIGS. 8, 9 and 10 illustrate settings corresponding to those of FIGS. 4, 5 and 7, respectively, but with the outer tip of the outwardly-facing pavilions, in the reversely-oriented gemstones, being formed with conventional culets, rather than being blunted.

FIGS. 11 and 12 illustrate conventional (i.e., not non-visible) settings for reversely-oriented gemstones mounted in accordance with the present invention.

FIGS. 13 and 14 illustrate the use of the array of FIG. 5 in exemplary items of jewelry according to embodiments of the present invention.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### THE PRIOR ART

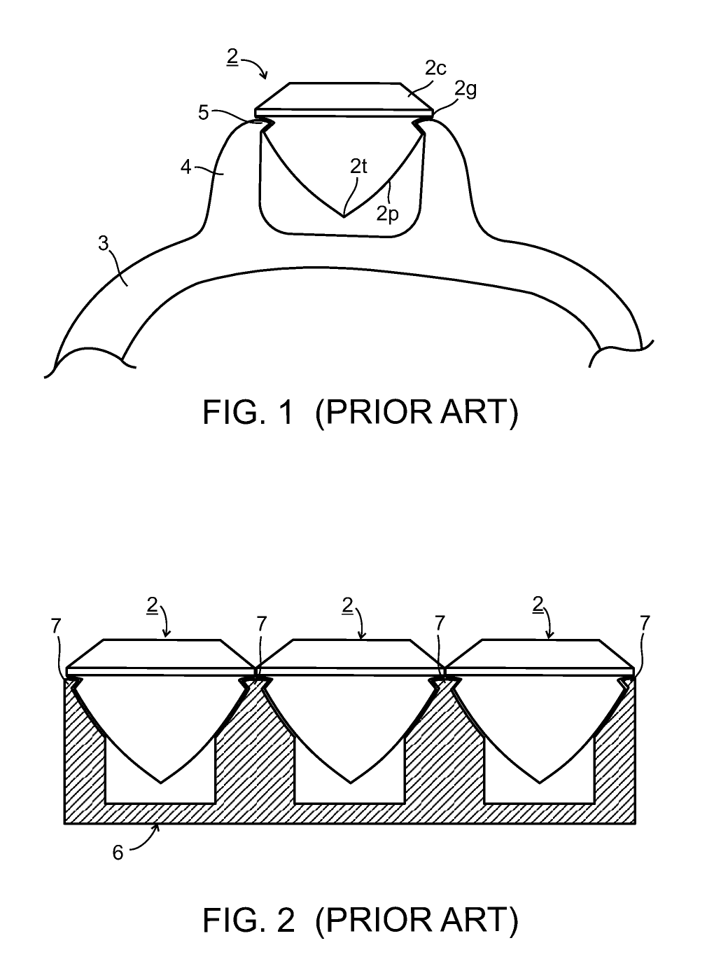

FIG. 1 illustrates a typical prior art setting for a diamond, generally designated 2. For purposes of example, diamond 2 is of the brilliant cut, including a girdle 2g, a crown 2c on one side of the girdle, and a pavilion 2p on the opposite side of the girdle. The girdle is generally defined as the portion of the diamond of largest cross-sectional area. The crown 2c tapers inwardly and generally terminates in a flat table. The pavilion 2p, of greater height than the crown, also tapers inwardly and terminates in a culet 2t. Both the crown 2c and the pavilion 2p are generally faceted according to the particular cut involved.

For purposes of example, FIG. 1 illustrates the diamond 2 as being mounted in a ring 3 by a conventional invisible setting 4. Such a setting includes a plurality of prongs 5 received within grooves or notches formed in the pavilion 2p of the diamond just below the girdle 2g. As shown in FIG. 1, in such a conventional invisible setting, the diamond is oriented such that the crown 2c faces outwardly, and the pavilion 2p faces inwardly.

Invisible settings are frequently used for mounting a plurality of diamonds contiguously to each other, as shown in FIG. 2, in order to create the appearance of a single large diamond. A typical invisible setting for a plurality of diamonds is illustrated in FIG. 2. In such invisible settings, the mounting, designated 6, is such that the girdles of the diamonds conceal the prongs of the mounting, shown at 7 in FIG. 2, to thereby create the appearance of a single large diamond, rather than a plurality of smaller diamonds. Such invisible settings for a plurality of diamonds are frequently used not only with respect to rings, but also with respect to pendants, bracelets and other jewelry articles.

### DESCRIPTION OF PREFERRED EMBODIMENTS OF THE PRESENT INVENTION

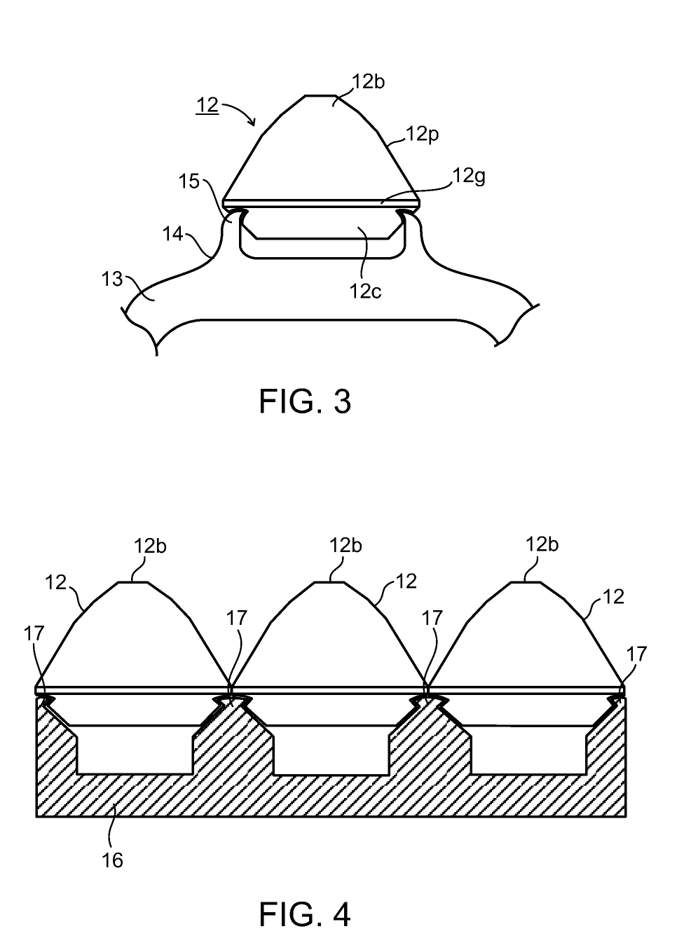

FIGS. 3 and 4 are views, corresponding to FIGS. 1 and 2, but illustrating the novel mounting producing an invisible setting for a single diamond (FIG. 3), or a plurality of diamonds (FIG. 4), in accordance with the present invention.

In FIG. 3 illustrating a diamond 12 mounted in a ring 13 by an invisible setting 14, it will be seen that the diamond 12 is mounted in an inverse orientation to the conventional setting arrangement of FIG. 1, namely with the pavilion 12p facing outwardly, and the crown 12c facing inwardly. For this purpose, the crown 12c is formed with the grooves or notches for receiving the prongs 15, with the prongs being concealed by the girdle 12g. In such a mounting, the tip of the pavilion 12p is preferably blunted, as shown at 12b.

FIG. 4 illustrates how a plurality of diamonds 12 may be mounted as described above with respect to FIG. 3 contiguously to each other in a common mounting 16, with the prongs 17 concealed by the girdles of the diamonds so as to create the appearance of a single large diamond, rather than a plurality of smaller diamonds.

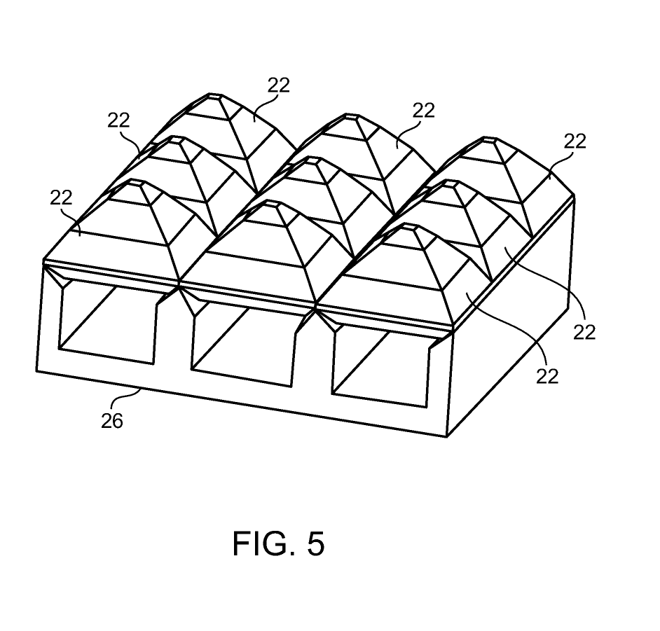

FIG. 4 illustrates a single row of diamonds 12 so mounted, whereas FIG. 5 diagrammatically illustrates how a plurality of rows of diamonds 22 can be so mounted, to create the appearance of a single large diamond. In FIGS. 4 and 5, all the diamonds are mounted in an inverse orientation manner as described above with respect to FIG. 3, i.e., with the pavilions facing outwardly and the crowns facing inwardly.

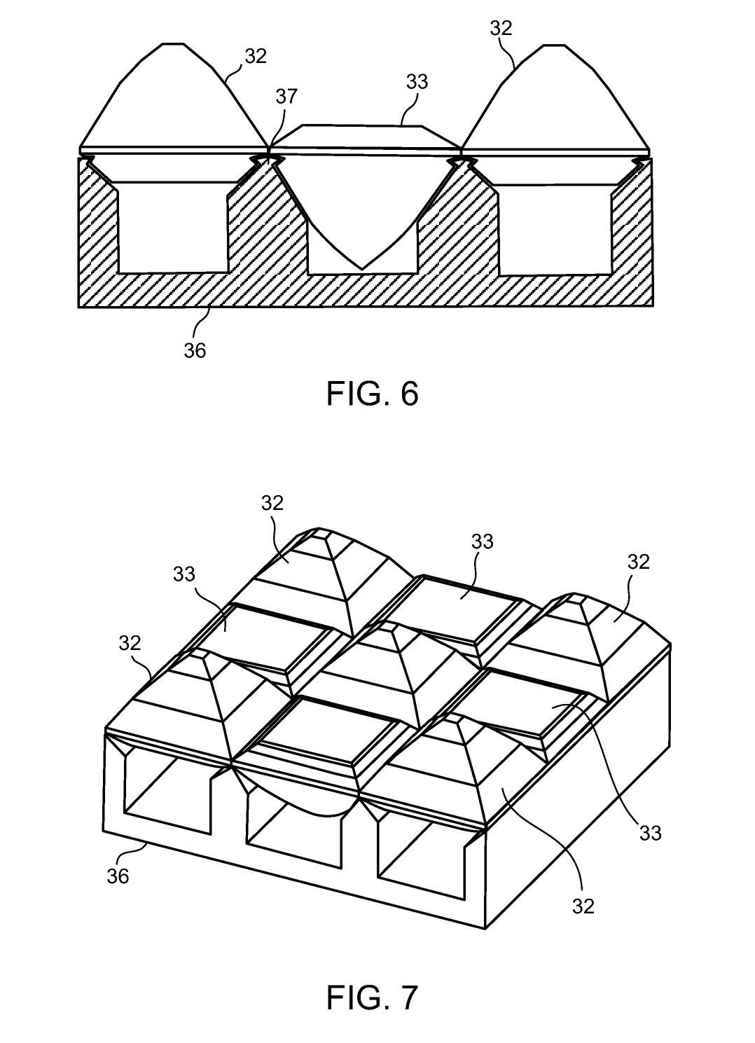

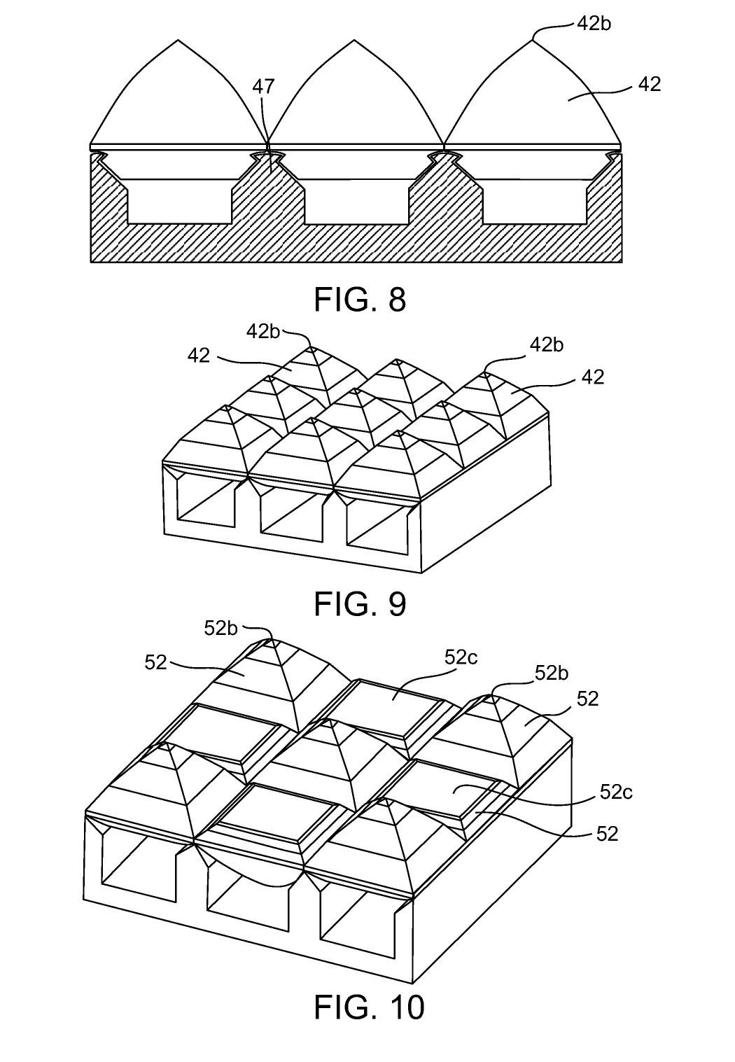

FIGS. 6 and 7 are views, corresponding to those of FIGS. 4 and 5, but showing another arrangement which may be used, namely wherein alternate diamonds 32 are mounted by invisible settings in an inverse orientation in a common mounting 36, as described above, with the pavilions facing outwardly; whereas the remaining alternate diamonds 33 are mounted in a conventional orientation as illustrated in FIGS. 1 and 2 with the crowns facing outwardly and the pavilions facing inwardly.

In the settings illustrated in FIGS. 3-7, the inversely-oriented gemstones, namely those with the pavilions facing outwardly (rather than inwardly), terminate in blunted tips, rather than in culets. It will be appreciated, however, that the pavilions in such inversely-oriented gemstones may also terminate in conventional culets, and this is shown for example in FIGS. 8-10, illustrating settings similar to those of FIGS. 4-7, respectively, but with conventional culets rather than blunted tips. Thus, FIGS. 8 and 9 illustrate an arrangement similar to that of FIG. 5, but with the tips of the pavilions 42 terminating in pointed culets 42b facing outwardly; and FIG. 10 illustrates an arrangement similar to that FIGS. 6 and 7, wherein alternate diamonds 52 are reversely mounted with their culets 52b facing outwardly and the other diamonds are mounted in the conventional manner with the tables 52c facing outwardly.

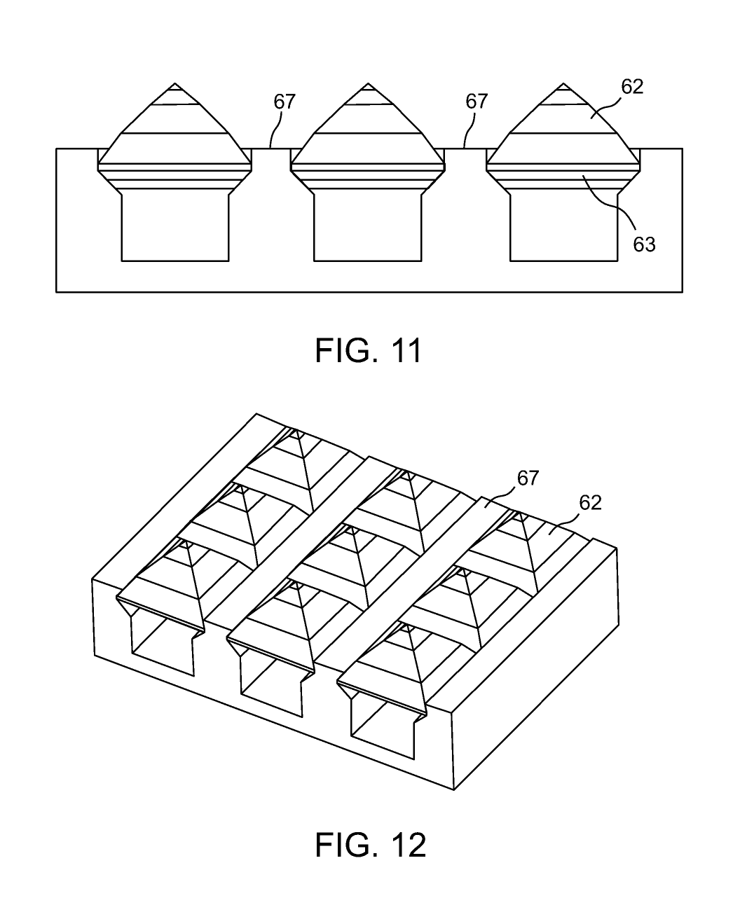

For purposes of example, FIGS. 11 and 12 illustrate reversely-oriented gemstones mounted in accordance with the present invention in conventional settings, e.g., visible settings. Thus, FIGS. 11 and 12 illustrate all the diamonds reversely mounted with their pavilions 62 facing outwardly, but with their settings 67 engaging grooves formed in the Settings 67, rather than in the crowns 63 of the gemstones, so that the settings 67 are visible.

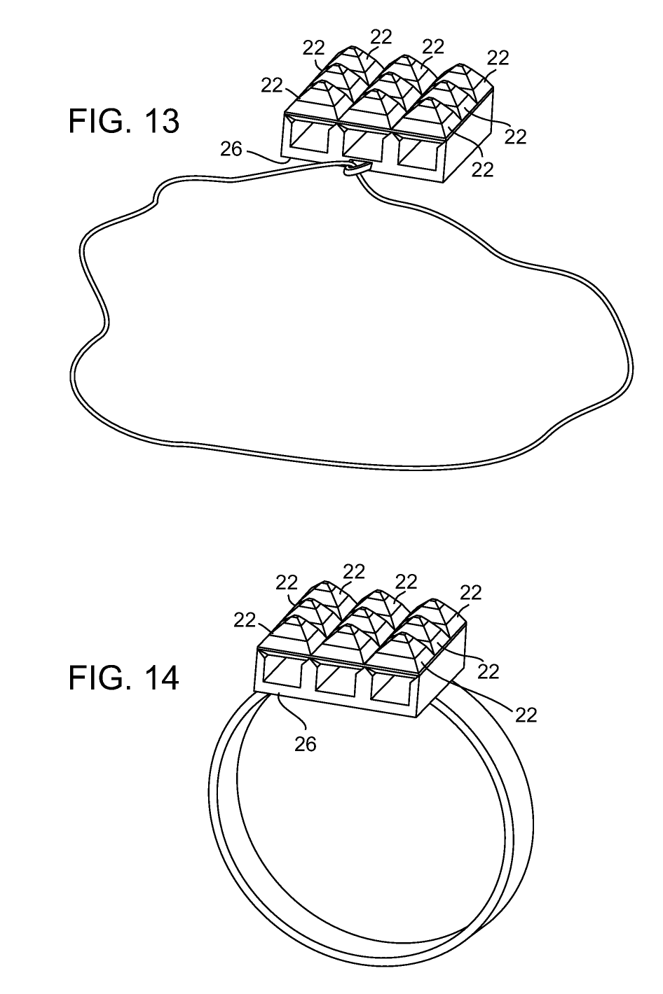

For example, FIG. 13 illustrates the use of the array of FIG. 5 in a pendant. FIG. 14 illustrates the use of the array of FIG. 5 in a ring.

It will be appreciated that the novel invisible setting as described above, and as illustrated particularly in FIGS. 3-10, could be used with respect to other types of gemstones, other types of jewelry, and other types gemstone cuts.

Many other variations, modifications and applications of the invention will be apparent.

What is claimed is:

1. A diamond comprising:
a girdle;
a pavilion on a first side of the girdle;
a crown on a second side of the girdle; and
grooves or notches formed in the crown.

2. A diamond according to claim 1, wherein the grooves or notches are adapted to receive means for mounting the diamond in a setting in an inverted orientation, with the pavilion facing outwards of the setting and the crown facing inwards of the setting.

3. A two by two array of diamonds according to claim 2, wherein the grooves or notches of the respective diamonds are adapted to receive the means for mounting the diamond in an invisible setting.

4. A two by two array according to claim 3, wherein the means for mounting are concealed from view by the diamonds.

5. A two by two array according to claim 3, wherein the means for mounting are concealed by the girdles of the respective diamonds.

6. A three by three array of diamonds according to claim 2, wherein the grooves or notches of the respective diamonds are adapted to receive the means for mounting the diamond in an invisible setting.

7. A three by three array according to claim 3, wherein the means for mounting are concealed from view by the diamonds.

8. A three by three array according to claim 3, wherein the means for mounting are concealed by the girdles of the respective diamonds.

9. A diamond according to claim 2, wherein the means for mounting comprise prongs.

10. A diamond according to claim 1, wherein a tip of the pavilion of the diamond is blunted.

11. A diamond according to claim 1, wherein a tip of the pavilion of the diamond terminates in a culet.

12. A diamond according to claim 1, wherein the diamond is a rectangular diamond.

13. A diamond according to claim 1, wherein the diamond is a square diamond.

14. A method of setting a diamond according to claim 1, the method comprising:
mounting said diamond by inserting means for mounting the diamond in said grooves or notches with the pavilion facing outwards of the setting and the crown facing inwards of the setting.

15. A method of setting a plurality of contiguous diamonds according to claim 1, the method comprising:
mounting said contiguous diamonds by inserting means for mounting the contiguous diamonds in said respective grooves or notches with the pavilion facing outwards of the setting and the crown facing inwards of the setting.

16. A method according to claim 15, comprising:
concealing said means for mounting by the girdles of the contiguous diamonds.

17. A method according to claim 15, comprising setting a two by two array of diamonds.

18. A method according to claim 15, comprising setting a three by three array of diamonds.

19. A method according to claim 15, further comprising:
mounting at least one additional gemstone in a standard orientation with the crown facing outwards of the setting and the pavilion facing inwards of the setting.

20. A method of cutting a diamond, the method comprising:
providing a diamond comprising a girdle, a pavilion on a first side of the girdle and a crown on a second side of the girdle; and
forming grooves or notches in the crown.

21. A method according to claim 20, further comprising blunting a tip of the pavilion.

22. An item of jewelry comprising:
a plurality of faceted gemstones including a girdle, a crown on one side of the girdle, and a pavilion on the opposite side of the girdle; and
a setting for contiguously setting said gemstones in an inverted orientation with the pavilion facing outwards of the setting and the crown facing inwards of the setting.

23. An item of jewelry according to claim 22, further comprising:
at least one additional gemstone mounted in the item, the additional gemstone comprising a girdle, a crown on one side of the girdle, and a pavilion on the opposite side of the girdle, the at least one additional gemstone mounted with the pavilion facing inwards of the setting and the crown facing outwards of the setting.

24. An item of jewelry according to claim 22, wherein a setting for contiguously setting said gemstones comprises setting for setting a row of contiguous gemstones.

25. An item of jewelry according to claim 24, wherein at least a portion of means for mounting said row of contiguous gemstones is visible.

26. An item of jewelry according to claim 22, wherein the item comprises a plurality of rows of contiguous gemstones.

27. An item of jewelry according to claim 26, wherein at least a portion of the setting is visible between said plurality of rows of contiguous gemstones.

28. An item of jewelry according to claim 22, wherein the setting is a visible setting.

29. An item of jewelry according to claim 22, wherein a tip of the pavilion of at least some of said gemstones is blunted.

30. An item of jewelry according to claim 22, wherein a tip of the pavilion of at least some of said gemstones terminates in a culet.

31. An item of jewelry according to claim 22, wherein the item is a ring.

32. An item of jewelry according to claim 22, wherein the item is a pendant.

33. An item of jewelry according to claim 22, wherein grooves or notches formed in the respective crowns of said plurality of faceted gemstones.

34. An item of jewelry according to claim 33, wherein said setting comprises means for mounting the gemstones inserted in said grooves or notches.

35. An item of jewelry according to claim 22, wherein said plurality of faceted gemstones comprise diamonds.

36. A method of producing an item of jewelry, the method comprising:
providing a setting for a plurality of gemstones; and
contiguously mounting faceted gemstones in the setting, the gemstones comprising a girdle, a pavilion on one side of the girdle and a crown on the opposite side of the girdle,
wherein said gemstones are mounted in an inverted orientation, with the pavilion of the gemstones facing outwardly of the setting and with the crown of the gemstones facing inwardly of the setting.

37. A method according to claim 36, further comprising:
mounting at least one additional gemstone mounted in the setting, the additional gemstone comprising a girdle, a crown on one side of the girdle, and a pavilion on the opposite side of the girdle, the at least one additional gemstone mounted with the pavilion facing inwards of the setting and the crown facing outwards of the setting.

38. A method according to claim 36, wherein contiguously mounting faceted gemstones in the setting comprises mounting at least one row of contiguous gemstones.

39. A method according to claim 38, wherein mounting at least one row of contiguous gemstones comprises mounting such that at least a portion of means for mounting said row of contiguous gemstones is visible.

40. A method according to claim 36, wherein contiguously mounting faceted gemstones in the setting comprises mounting a plurality of rows of contiguous gemstones.

41. A method according to claim 40, wherein mounting a plurality of rows of contiguous gemstones comprises mounting such that at least a portion of the means for mounting said plurality of rows is visible between said plurality of rows of contiguous gemstones.

42. A method according to claim 36, wherein mounting faceted gemstones in a setting comprises inserting means for mounting in grooves or notches formed in the crowns of the respective gemstones.

43. A method according to claim 36, wherein providing a setting comprises providing a visible setting.

44. A method according to claim 36, wherein contiguously mounting faceted gemstones in the setting comprises mounting at least some gemstones comprising a blunted tip of the pavilion.

45. A method according to claim 36, wherein contiguously mounting faceted gemstones in the setting comprises mounting at least some gemstones comprising a pavilion terminating in a culet.

46. A method according to claim 36 comprising a method of producing a ring.

47. A method according to claim 36 comprising a method of producing a pendant.

48. A method according to claim 36, wherein said gemstones comprise diamonds.
